(19) United States
(12) Patent Application Publication
(10) Pub. No.: US 2009/0103970 A1
(43) Pub. Date: Apr. 23, 2009

(54) COSMETICS APPLIANCE

(76) Inventor: Young Gu LEE, Anyang City (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/957,581

(22) Filed: Dec. 17, 2007

(30) Foreign Application Priority Data
Oct. 17, 2007 (KR) 20-2007-0016796

(51) Int. Cl. B43K 5/04; B43K 23/12

(52) U.S. Cl. 401/262; 401/265

(57) ABSTRACT

Disclosed is a cosmetic appliance including a container having an outlet formed on an upper surface; a discharge tube coupled to the container so as to communicate with the outlet; an application member having a main application surface lying at an angle relative to a longitudinal direction of the discharge tube and having a discharge hole formed in a region, and a main peripheral surface cooperating with the main application surface so as to surround the discharge tube, the application member being installed so that the discharge hole communicates with the discharge tube; and a container cap having a cup-shaped cap body and a sealing protrusion formed on a bottom surface of the cap body, the container cap being coupled to the container so that the sealing protrusion enters into the discharge hole and the cap body surrounds the application member.

### BACKGROUND OF THE INVENTION

1. Field of the Invention

The present invention relates to a cosmetic appliance, and more particularly to a cosmetic appliance having a container for storing a liquid cosmetic product and an application member for dispensing the product based on an external operation.

2. Description of the Prior Art

As generally known in the art, conventional cosmetic products (e.g. foundation, lipstick) have been used in a solid or powder state, but it is becoming widespread to store a liquid cosmetic product in a container and use an application member (e.g. brush) to apply the product for more convenient use.

FIGS. 7 and 8 are exploded perspective views of a conventional cosmetic appliance, and FIG. 9 is an assembled perspective view thereof.

Referring to the drawings, the conventional cosmetic appliance includes a container 110 having an outlet 111a formed on the upper surface, a discharge tube 120 coupled to the container 110 so as to communicate with the outlet 111a, an application member 130 coupled to the container 110 so as to surround the discharge tube 120, and a container cap 140 coupled to the container 110 so as to surround the application member 130.

The container 110 has a reservoir 111 having an outlet 111a formed on its upper surface, and a ring-shaped shoulder 112 coupled to the top of the reservoir 111.

The reservoir 111 has an elliptical sectional shape, and a crest 111b is formed around the outlet 111a on the upper surface.

The reservoir 111, which is constructed as mentioned above, is made of a flexible material, such as a low-density polyethylene (LDPE).

The crest 111b protrudes from the entire upper circumference in the same direction as an engaging rib 111c extends away from the outlet 111a.

The crest 111b is raised in such a manner that a support tube 111d communicates with the outlet 111a on the upper surface.

The shoulder 112 has an elliptical sectional shape, and coupling protrusions 112a are formed on its outer surface and distributed along the circumference.

The shoulder 112, which is constructed as mentioned above, is coupled to the reservoir 111 by press-fitting an engaging step 112b, which is formed on the inner surface, between the engaging rib 111c and the upper surface of the reservoir 111.

The discharge tube 120 is coupled to the container 110 so as to reach the outlet 111a through the support tube 111d. As a result, the discharge tube 120 communicates with the outlet 111a.

The application member 130 has a main application surface 131 lying at an angle relative to the longitudinal direction of the discharge tube 120, and a main peripheral surface 132 formed to surround the discharge tube 120 while cooperating with the main application surface 131.

The main application surface 131 has a discharge hole 131a formed in its central region.

The application member 130 is formed as an integral unit with the discharge tube 120 so that the discharge hole 131a communicates with the discharge tube 120.

The application member 130, which is constructed as mentioned above, is coupled to the container 110 while the lower end of the main peripheral surface 132 is supported on the upper end of the shoulder 112.

The container cap 140 has a cup-shaped cap body 141 and a sealing protrusion 142 formed on the bottom surface of the cap body 141.

The cap body 141 has an elliptical sectional surface, and coupling recesses 141a are formed in the lower region of the inner surface so as to correspond to the coupling protrusions 112a.

The sealing protrusion 142 has a reinforcement rib 142a formed on the bottom surface of the cap body 141 in an approximately cross shape, and a sealing post 142b extending from the center of the reinforcement rib 142a in a direction facing away from the bottom surface of the cap body 141.

The sealing post 142b has a shape complementary to that of the discharge hole 131a.

The container cap 140, which is constructed as mentioned above, is coupled to the container 110 by compressing it toward the reservoir 111 so that the coupling protrusions 112a enter into the coupling recesses 141a. Particularly, the container cap 140 is coupled to the container 110 so that the sealing post 142b enters into the outlet 131a and the cap body 141 surrounds the application member 130.

A method for using the conventional cosmetic appliance, which is constructed as mentioned above, will now be described. It will be assumed for convenience of description that the container cap 140 is coupled to the container 110.

Firstly, the container cap 140 is removed from the container 110, and the reservoir 111 is compressed.

The compression of the reservoir 111 causes the liquid cosmetic product, which is stored in the reservoir 111, to flow into the inner space of the discharge tube 120 via the lower opening of the discharge tube 120 and the guide recess 120a.

After entering into the discharge tube 120, the liquid cosmetic product is supplied to the main application surface 131 via the discharge hole 131a.

The main application surface 131, to which the liquid cosmetic product is supplied, is rubbed against the skin.

As the main application surface 131 is rubbed against the skin, the liquid cosmetic product is distributed over the main application surface 131, and is absorbed by the skin.

After the cosmetic product is spread over the skin as much as necessary, the container cap 140 is coupled to the container 110 again.

However, the conventional cosmetic appliance has a problem in that, when the liquid cosmetic product is supplied via the discharge hole 131a to be applied, it may stay on the main application surface 131 only. This means that the effective application area is reduced, and the loss of cosmetic product increases (because a portion of the cosmetic product is not applied via the main application surface but just flows down).

If the discharge hole 131a is enlarged in an effort to reduce the loss of the cosmetic product, it becomes difficult to properly apply a high-density cosmetic product, because the product cannot be supplied efficiently via the discharge hole 131a.

### SUMMARY OF THE INVENTION

Accordingly, the present invention has been made to solve the above-mentioned problems occurring in the prior art, and the present invention provides a cosmetic appliance having an increased effective application area while reducing the loss of a cosmetic product.

In accordance with an aspect of the present invention, there is provided a cosmetic appliance including a container having an outlet formed on an upper surface; a discharge tube coupled to the container so as to communicate with the outlet; an application member having a main application surface and a main peripheral surface, the main application surface lying at an angle relative to a longitudinal direction of the discharge tube and having a discharge hole formed in a region, the main peripheral surface cooperating with the main application surface so as to surround the discharge tube, the application member being installed so that the discharge hole communicates with the discharge tube; and a container cap having a cup-shaped cap body and a sealing protrusion formed on a bottom surface of the cap body, the container cap being coupled to the container so that the sealing protrusion enters into the discharge hole and the cap body surrounds the application member, wherein the application member has an auxiliary application surface extending from an upper end of the main application surface past the main peripheral surface at an angle not smaller than the angle of the main application surface relative to the longitudinal direction of the discharge tube, and an auxiliary peripheral surface connecting the auxiliary application surface to the main peripheral surface.

Preferably, in order to ensure that the discharge tube remains stably coupled to the container, the discharge tube has a guide recess extending from a lower end in the longitudinal direction, and the discharge tube is coupled to the container so that the guide recess enters into the container past the outlet.

### BRIEF DESCRIPTION OF THE DRAWINGS

The above and other objects, features, and advantages of the present invention will be more apparent from the following detailed description taken in conjunction with the accompanying drawings, in which:

FIGS. 1 and 2 are exploded perspective views of a cosmetic appliance according to an embodiment of the present invention;

FIG. 3 is an assembled sectional view of a cosmetic appliance according to an embodiment of the present invention;

FIGS. 4 and 5 are detailed views of an application member and a discharge tube of the cosmetic appliance shown in FIG. 1, respectively;

FIG. 6 is an assembled sectional view of a cosmetic appliance according to another embodiment of the present invention;

FIGS. 7 and 8 are exploded perspective views of a cosmetic appliance according to the prior art; and

FIG. 9 is an assembled sectional view of a cosmetic appliance according to the prior art.

### DETAILED DESCRIPTION OF THE EXEMPLARY EMBODIMENTS

Hereinafter, a exemplary embodiment of the present invention will be described with reference to the accompanying drawings. In the following description and drawings, the same reference numerals are used to designate the same or similar components, and so repetition of the description on the same or similar components will be omitted.

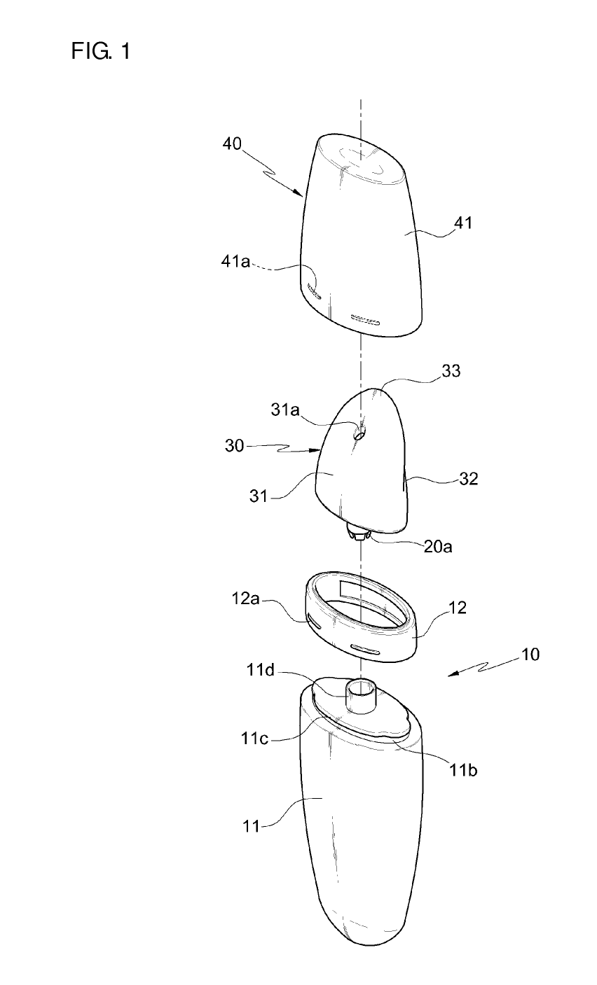

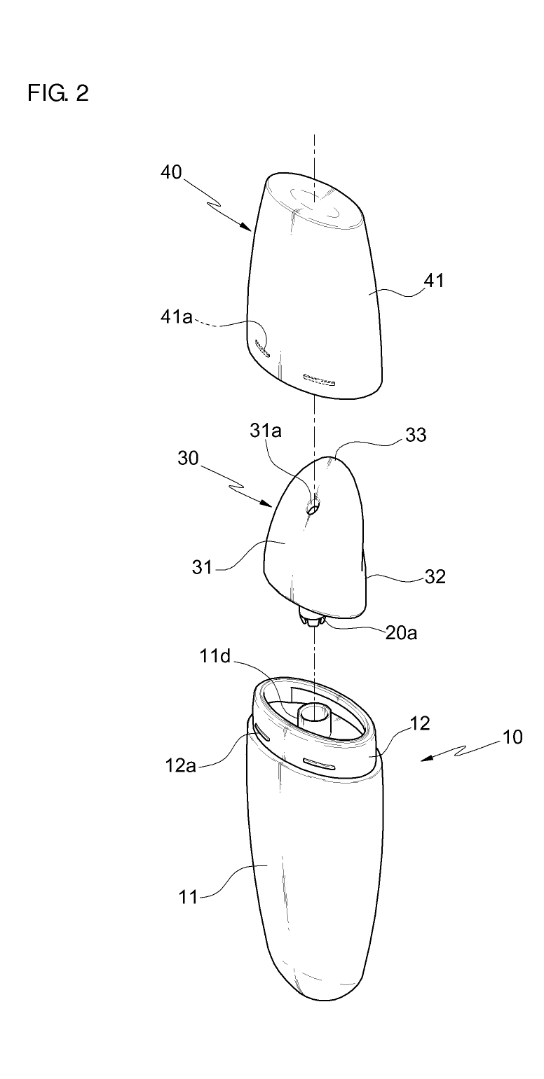

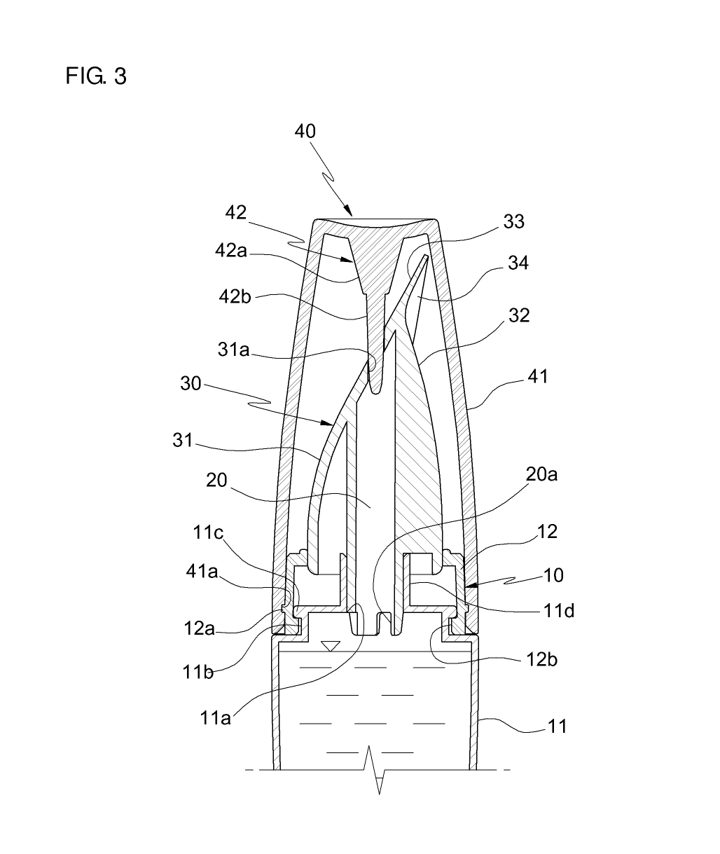

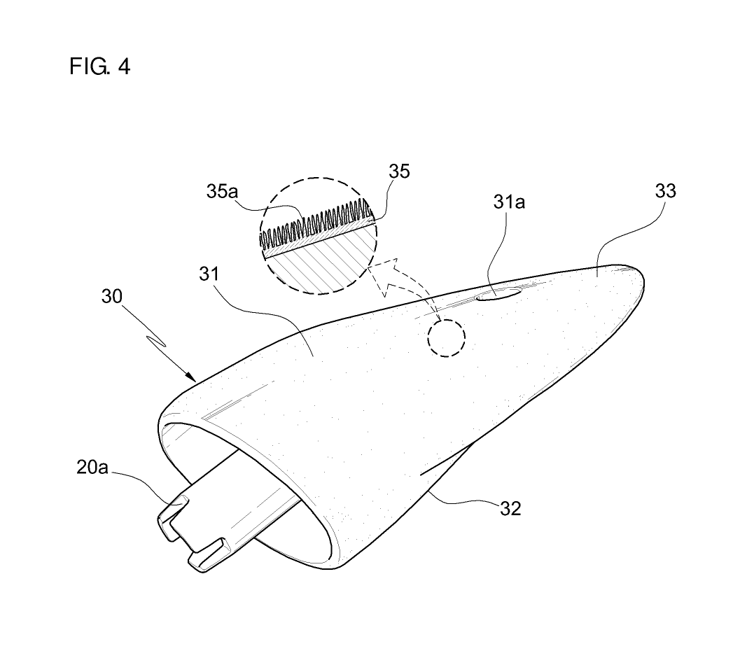

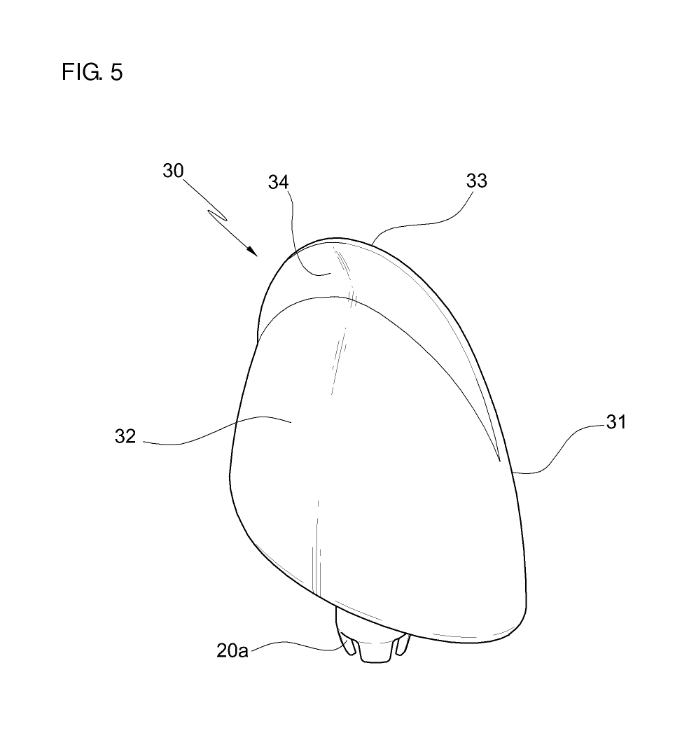

FIGS. 1 and 2 are exploded perspective views of a cosmetic appliance according to an embodiment of the present invention, FIG. 3 is an assembled sectional view of a cosmetic appliance according to an embodiment of the present invention, and FIGS. 4 and 5 are detailed views of an application member and a discharge tube of the cosmetic appliance shown in FIG. 1, respectively.

Referring to the drawings, the cosmetic appliance according to an embodiment of the present invention includes a container 10 having an outlet 11a formed on the upper surface, a discharge tube 20 coupled to the container 10 so as to communicate with the outlet 11a, an application member 30 coupled to the container 10 so as to surround the discharge tube 20, and a container cap 40 coupled to the container 10 so as to surround the application member 30.

The container 10 has a reservoir 11 having an outlet 11a formed on its upper surface, and a ring-shaped shoulder 12 coupled to the top of the reservoir 11.

The reservoir 11 has an elliptical sectional shape, and a crest 11b is formed around the outlet 11a on the upper surface.

The reservoir 11, which is constructed as mentioned above, is made of a flexible material, such as a low-density polyethylene (LDPE).

The crest 11b protrudes from the entire upper circumference in the same direction as an engaging rib 11c extends away from the outlet 11a.

The crest 11b is erected in such a manner that a support tube lid communicates with the outlet 11a on the upper surface.

The shoulder 12 has an elliptical sectional shape, and coupling protrusions 12a are formed on its outer surface and distributed along the circumference.

The shoulder 12, which is constructed as mentioned above, is coupled to the reservoir 11 by press-fitting an engaging step 12b, which is formed on the inner surface, between the engaging rib 11c and the upper surface of the reservoir 11.

The discharge tube 20 has a guide recess 20a formed in the longitudinal direction from the lower end.

The discharge tube 20, which is constructed as mentioned above, is coupled to the container 10 so that the guide recess 20a enters into the container 10 through the support tube lid and past the outlet 11a. As a result, the discharge tube 20 communicates with the outlet 11a.

The application member 30 has a main application surface 31 lying at an angle relative to the longitudinal direction of the discharge tube 20, a main peripheral surface 32 formed so as to surround the discharge tube 20 while cooperating with the main application surface 31, an auxiliary application surface 33 extending from the upper end of the main application surface 31, and an auxiliary peripheral surface 34 connecting the auxiliary application surface 33 to the main peripheral surface 32.

The main application surface 31 has a discharge hole 31a formed in its central region, a furry layer 35 made of cloth and formed around the discharge hole 31a of the main application surface 31, and a number of absorption bristles 35a attached to the surface of the furry layer 35.

The auxiliary application surface 33 extends from the upper end of the main auxiliary surface 31 past the main peripheral surface 32 at the same angle as that of the main application surface 31 relative to the longitudinal direction of the discharge tube 20.

The application member 30 is formed as an integral unit with the discharge tube 20 so that the discharge hole 31a communicates with the discharge tube 20.

The application member 30, which is constructed as mentioned above, is coupled to the container 10 while the lower end of the main peripheral surface 32 is supported on the upper end of the shoulder 12.

The container cap 40 has a cup-shaped cap body 41 and a sealing protrusion 42 formed on the bottom surface of the cap body 41.

The cap body 41 has an elliptical sectional surface, and coupling recesses 41a are formed in the lower region of the inner surface so as to correspond to the coupling protrusions 12a.

The sealing protrusion 42 has a reinforcement rib 42a formed on the bottom surface of the cap body 41 in an approximately cross shape, and a sealing post 42b extending from the center of the reinforcement rib 42a in a direction facing away from the bottom surface of the cap body 41.

The sealing post 42b has a shape complementary to that of the discharge hole 31a.

The container cap 40, which is constructed as mentioned above, is coupled to the container 10 by compressing it toward the reservoir 11 so that the coupling protrusions 12a enter into the coupling recesses 41a. Particularly, the container cap 40 is coupled to the container 10 so that the sealing post 42b enters into the outlet 31a and the cap body 41 surrounds the application member 30.

A method for using the cosmetic appliance according to an embodiment of the present invention, which is constructed as mentioned above, will now be described. It will be assumed for convenience of description that the container cap 40 is coupled to the container 10.

Firstly, the container cap 40 is removed from the container 10, and the reservoir 11 is compressed.

The compression of the reservoir 11 causes the liquid cosmetic product, which is stored in the reservoir 11, to flow into the inner space of the discharge tube 20 via the lower opening of the discharge tube 20 and the guide recess 20a.

After entering into the discharge tube 20, the liquid cosmetic product is supplied to the main application surface 31 via the discharge hole 31a.

The main application surface 31, to which the liquid cosmetic product is supplied, is rubbed against the skin.

As the main application surface 31 is rubbed against the skin, the liquid cosmetic product is distributed over the main application surface 31 and the auxiliary application surface 33, and is absorbed by the skin.

After the cosmetic product is spread over the skin as much as necessary, the container cap 40 is coupled to the container 10 again.

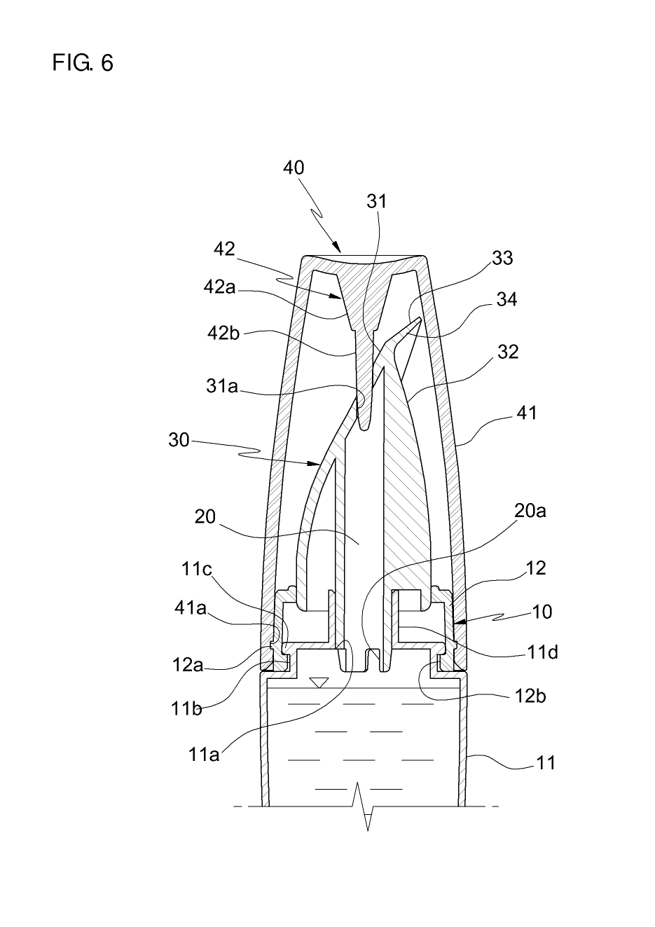

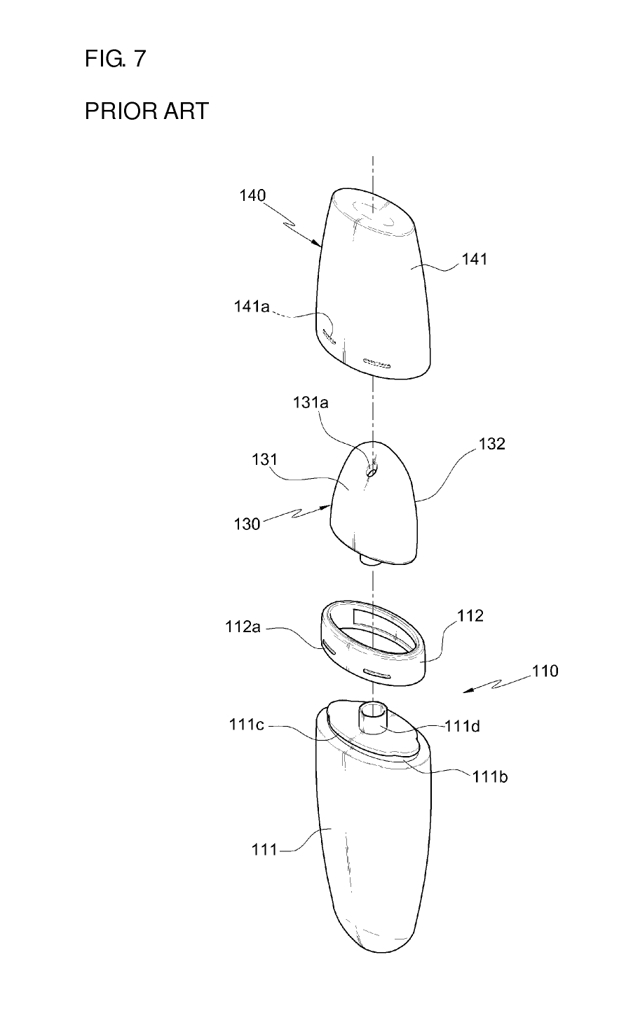

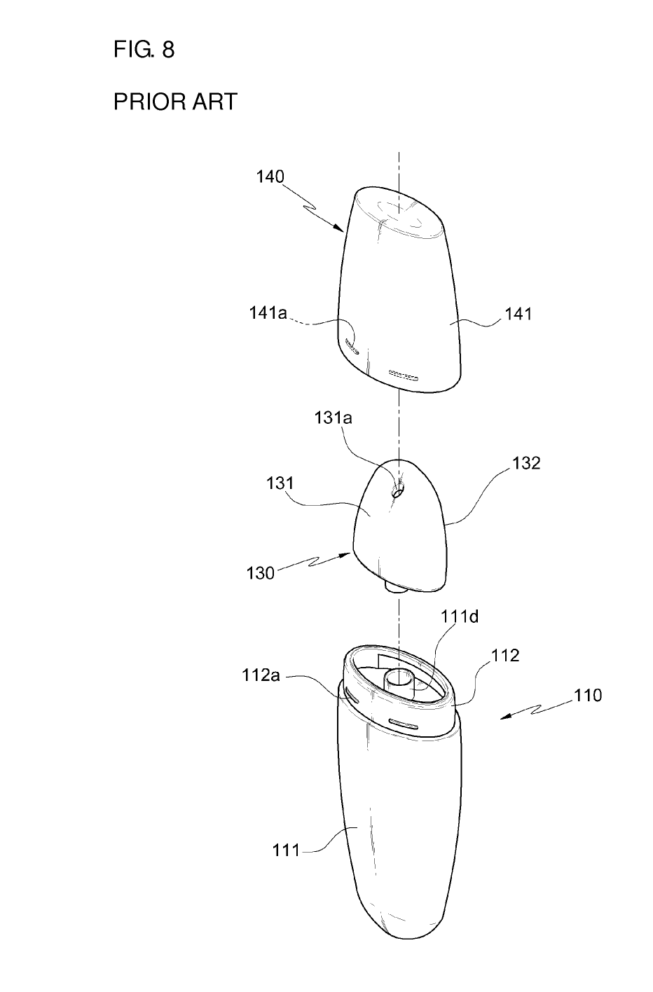

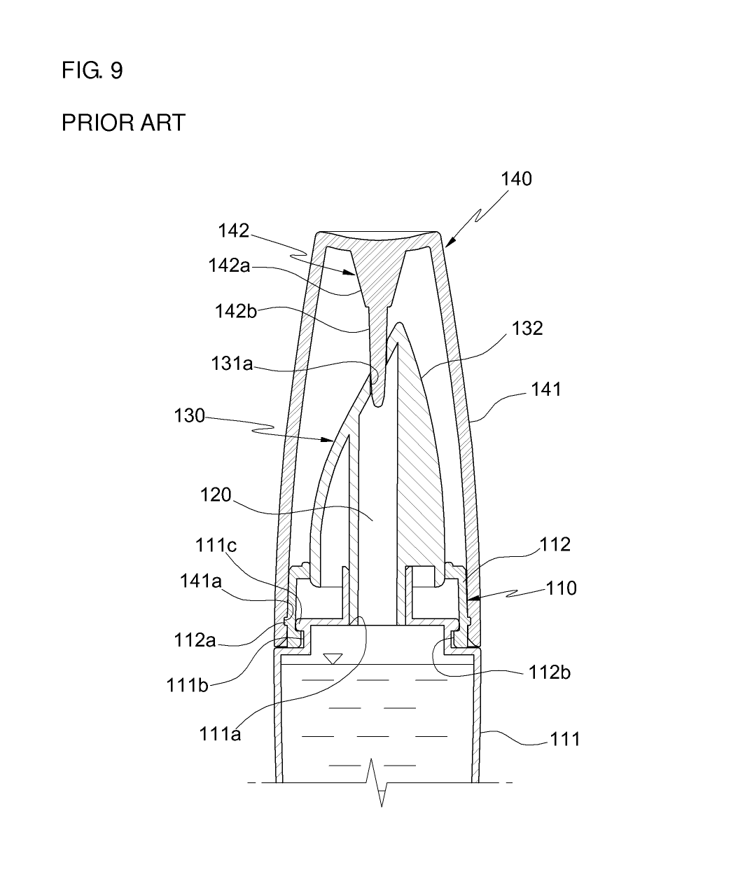

Although it has been assumed in the above description of an embodiment of the present invention that the auxiliary application surface 33 lies at the same angle as that of the main application surface 31 relative to the longitudinal direction of the discharge tube 20, the auxiliary application surface 33 may lie at an angle larger than that of the main application surface 31 relative to the longitudinal direction of the discharge tube 20, as shown in FIG. 6.

As mentioned above, the cosmetic appliance according to an embodiment of the present invention is advantageous in that, by providing the application member 30 with the auxiliary application surface 33, the effective application area is increased while the loss of the cosmetic product is reduced.

The fact that it is unnecessary to enlarge the discharge hole 31a to reduce the loss of the cosmetic product makes it easier to use as a cosmetic appliance for a high-density liquid cosmetic product.

Furthermore, by coupling the discharge tube 20 to the container 10 so that the guide recess 20a enters into the container 10 via the outlet 11a, the discharge tube 20 remains stably coupled to the container 10.

In summary, the cosmetic appliance according to the present invention advantageously has an increased effective application area and a reduced amount of lost cosmetic product by providing the application member with an auxiliary application surface. The cosmetic appliance is also compatible with a high-density liquid cosmetic product.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A cosmetic appliance comprising:
a container having an outlet formed on an upper surface;
a discharge tube coupled to the container so as to communicate with the outlet;
an application member having a main application surface and a main peripheral surface, the main application surface lying at an angle relative to a longitudinal direction of the discharge tube and having a discharge hole formed in a region, the main peripheral surface cooperating with the main application surface so as to surround the discharge tube, the application member being installed so that the discharge hole communicates with the discharge tube; and
a container cap having a cup-shaped cap body and a sealing protrusion formed on a bottom surface of the cap body, the container cap being coupled to the container so that the sealing protrusion enters into the discharge hole and the cap body surrounds the application member, wherein
the application member has an auxiliary application surface extending from an upper end of the main application surface past the main peripheral surface at an angle not smaller than the angle of the main application surface relative to the longitudinal direction of the discharge tube, and an auxiliary peripheral surface connecting the auxiliary application surface to the main peripheral surface.

2. The cosmetic appliance as claimed in claim 1, wherein the discharge tube has a guide recess extending from a lower end in the longitudinal direction, and the discharge tube is coupled to the container so that the guide recess enters into the container past the outlet.
